(19) United States
(12) Patent Application Publication
(10) Pub. No.: US 2017/0016623 A1
(43) Pub. Date: Jan. 19, 2017

(54) AUTOMATED COOKING DEVICE AND METHOD

(71) Applicant: Tovala, Chicago, IL (US)

(72) Inventors: David Rabie, Chicago, IL (US); Aubrey Donnellan, Boca Raton, FL (US); Bryan Wilcox, Mahomet, IL (US); Peter Fiflis, Chicago, IL (US); Adam Brakhane, Chicago, IL (US)

(73) Assignee: Tovala, Chicago, IL (US)

(21) Appl. No.: 15/210,671

(22) Filed: Jul. 14, 2016

Related U.S. Application Data
(60) Provisional application No. 62/192,207, filed on Jul. 14, 2015.

(51) Int. Cl. F24C 7/08; A47J 37/06

(52) U.S. Cl. CPC F24C 7/088; A47J 37/0629

(57) ABSTRACT

One embodiment relates to an automated cooking device. An example automated cooking device includes an enclosure defining a cooking chamber. A heating element is positioned in the cooking chamber. A boiler and a fan are also operatively coupled to the cooking chamber. A scanner is structured to read a unique identifier on a food product. A controller is operatively coupled to each of the heating element, the boiler, the fan, and the scanner. The unique identifier is transmitted to a backend system in response to the scanner reading the unique identifier on the food product. Cooking instructions for controllably operating at least one of the heating element, the boiler, and the fan so as to cook the food product are received. The at least one of the heating element, the boiler, and the fan are controllably operated based on the cooking instructions so as to cook the food product.

### CROSS-REFERENCE TO RELATED APPLICATIONS

This application claims the benefit of priority to U.S. Provisional Patent Application No. 62/190,207, filed Jul. 14, 2015, which is hereby incorporated by reference in its entirety.

### BACKGROUND

Various appliances exist for cooking food items. Some cooking appliances are capable of cooking using multiple cooking methods. For example, some ovens are capable of both baking and broiling. Other combination ovens are additionally capable of microwave cooking. However, conventional combination ovens are expensive and difficult to use. For example, many individuals are not familiar or comfortable with recipes that require more than one cooking method.

### SUMMARY

One embodiment relates to an automated cooking device. An example automated cooking device includes an enclosure defining a cooking chamber. A heating element is positioned in the cooking chamber. The heating element is structured to controllably heat the cooking chamber. A boiler is operatively coupled to the cooking chamber. The boiler is structured to controllably inject steam into the cooking chamber. A fan is operatively coupled to the cooking chamber. The fan structured to circulate air within the cooking chamber. A scanner is structured to read a unique identifier on a food product. A controller is operatively coupled to each of the heating element, the boiler, the fan, and the scanner. The unique identifier is transmitted to a backend system in response to the scanner reading the unique identifier on the food product. Cooking instructions for controllably operating at least one of the heating element, the boiler, and the fan so as to cook the food product are received from the backend system. The at least one of the heating element, the boiler, and the fan are controllably operated based on the cooking instructions so as to cook the food product.

Another embodiment relates to method. An example method includes assigning unique identifiers to each of a plurality of food products. The plurality of food products includes a plurality of food product types. Cooking instructions for cooking each of the food product types are defined. A first unique identifier is received from a first automated cooking device. The first unique identifier corresponds to a first one of the plurality of food products. The first unique identifier has been scanned by the first automated cooking device from the first food product. The food product type corresponding to the first food product is determined. The cooking instructions corresponding to the first food product type are determined. The determined cooking instructions are transmitted to the first automated cooking device. The first automated cooking device is structured to cook the first food product according to the determined cooking instructions.

Another embodiment relates to a method. An example method includes characterizing thermal properties of a cooking device. The cooking device defines a cooking chamber. Thermal properties of a food product are also characterized. A parametric temperature map model is defined based on the thermal properties of each of the cooking device and the food product. Nominal cooking instructions for cooking the food product are received. Initial conditions of the cooking device and the food product are determined upon the food product being placed in the cooking chamber, based on first temperature measurements from each of a first temperature sensor positioned proximate a wall of the cooking chamber and a second temperature sensor positioned within the cooking chamber and spaced from the wall. Initial cooking instructions are determined by modifying the nominal cooking instructions based on the initial conditions. The heating element is operated so as to cook the food product according to the initial cooking instructions. Second temperature measurements from each of the first and second temperature sensors are monitored over time throughout operation of the heating element. A spatial temperature map of temperatures throughout the cooking chamber is analyzed based on the second temperature measurements applied to the parametric temperature map model. Controllable operation of the heating element is dynamically adjusted based on the analysis of the spatial temperature map.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims.

FIG. 1 is a block diagram of an automated cooking system, according to an example embodiment.

FIG. 2 is a front perspective view of the cooking device of FIG. 1, according to an embodiment.

FIG. 3 is a block diagram of the backend system of FIG. 1, according to an example embodiment.

FIG. 4 is a block diagram of the user device of FIG. 1, according to an example embodiment.

FIG. 5 is a flowchart illustrating a method of initiating a cooking process using the cooking device of FIG. 1, according to an example embodiment.

FIG. 6 is a flowchart illustrating a method of dynamically adjusting a cooking profile of a food product, according to an example embodiment.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

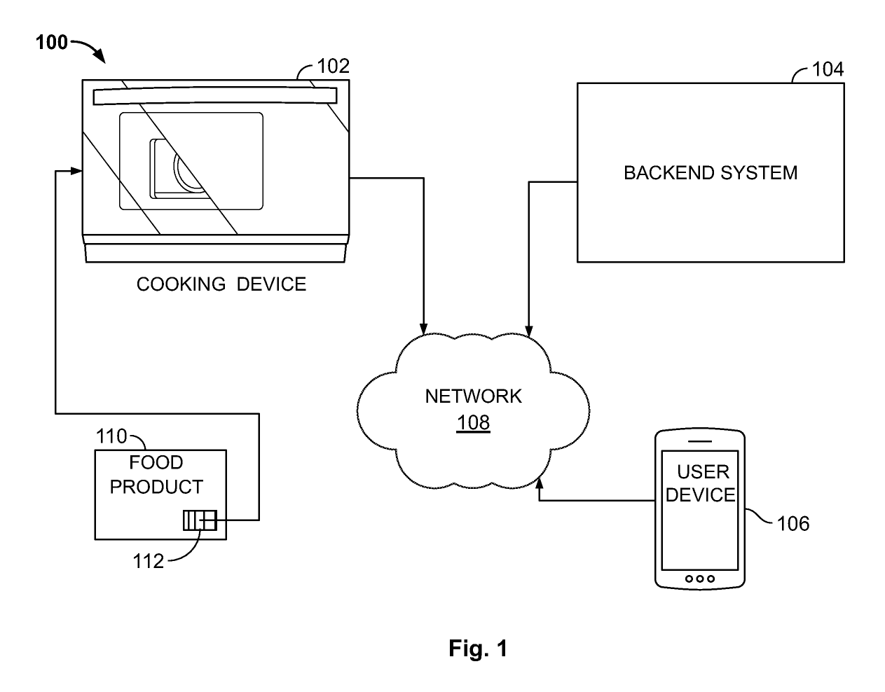

FIG. 1 is a block diagram of an automated cooking system 100, according to an example embodiment. The automated cooking system 100 includes a cooking device 102, a backend system 104, and a user device 106, each being in operative communication over a network 108. As will be appreciated, the cooking device 102 is structured to cook a food product 110 using a combination of wet and dry heat. For example, the cooking device 102 is structured to cook the food product 110 according to one or more cooking methods, such as baking, broiling, convection roasting, steaming, etc., or any combination thereof.

The food product 110 includes a unique identifier 112 assigned to the food product 110. The unique identifier may be represented on packaging of the food product 110 via a one- or two-dimensional bar code, QR code, etc., which may be displayed on an outer surface of a container of the food product 110. In one embodiment, the unique identifier 112 is covered by a peel-off label so as to prevent the unique identifier 112 from being copied prior to authorized use. In some embodiments, the unique identifier 112 is stored on an embedded circuit (e.g., disposed on or in the container of the food product 110).

In order to cook the food product 110, a user scans the unique identifier 112 of the food product 110 using a scanner of the cooking device 102. The cooking device 102 transmits the unique identifier 112 to the backend system 104, and the backend system 104 returns to the cooking device 102 cooking instructions for cooking the food product 110. The cooking device 102 then cooks the food product 110 according to the cooking instructions. The cooking instructions define one or more steps of a cooking profile, with each of the steps including one or more cooking methods (e.g., bake), a temperature (e.g., 400 degrees F.), and an amount of time associated therewith (e.g., for five minutes). In some embodiments, the cooking instructions may also include a humidity value (e.g., at 100% humidity). The cooking device 102 automatically performs all of the steps of the cooking instructions to cook the food product 110 in a controlled and optimized manner. Accordingly, the cooking device 102 provides optimal and highly consistent cooking with minimal effort needed by a user.

The cooking device 102 is structured to operate in an automated mode or a manual mode. In the automated mode, as described above, the cooking device 102 automatically cooks the food product 110 based on cooking instructions received from the backend system 104 in response to scanning and transmitting the unique identifier 112 of the food product 110. In the manual mode, a user can develop custom recipes for the food product 110, and manually define the cooking instructions for cooking the food product 110. The cooking instructions may be defined via user input to the user device 106, the cooking device 102, and/or other systems and devices.

In some embodiments, the backend system 104 is structured to automatically tailor cooking processes for individual users based on preferences received from the individual users and/or based on usage trends of the individual users. For example users may provide feedback on the taste, doneness, portion size, visual appeal, etc. of the food product 110. In some embodiments, cooking preferences are determined automatically based on user interaction with the cooking device 102. As discussed in further detail below, the backend system 104 is structured to modify nominal cooking instructions of particular food products 110 to cook the food product 110 to the personal user's preferences.

In some embodiments, the backend system 104 is structured to dynamically adjusting a cooking profile of a food product 110 based on advanced dynamic temperature analyses that monitor the thermal response of the cooking device 102 food product 110 relative to the heating inputs specified by the cooking instructions to fine-tailor the cooking profile to the particular food product 110. This enables perfect cooking of the food product 110 regardless of the initial conditions of the food product 110. For example, whether the food product 110 is completely frozen, partially defrosted, or refrigerated, the cooking device 102 automatically and dynamically adjusts the cooking profile to ensure that the food product 110 is perfectly cooked.

Instead of using a temperature probe that is inserted into the food product to measure its temperature response over time, as with conventional cooking devices, the cooking device 102 and the backend system 104 are structured to determine the temperature of the food product 110 with high precision without actually having to directly measure the temperature of the food product (e.g., via a temperature probe). Instead, as will be appreciated, a dynamic spatial temperature map of the cooking device 102 and of the food product 110 is generated based on as few as two temperature measurements using an advanced parametric model.

In some embodiments, the backend system 104 is structured to provide a marketplace through which users can purchase, trade, and/or share cooking instructions and/or recipes for cooking food products. The marketplace provides a social and entrepreneurial aspect to using the cooking device 102 by enabling users to share discuss, review, and sell cooking profiles and/or recipes. Some embodiments include a revenue sharing model in which users keep a percentage of sales for all of the cooking profiles and/or recipes that they have posted.

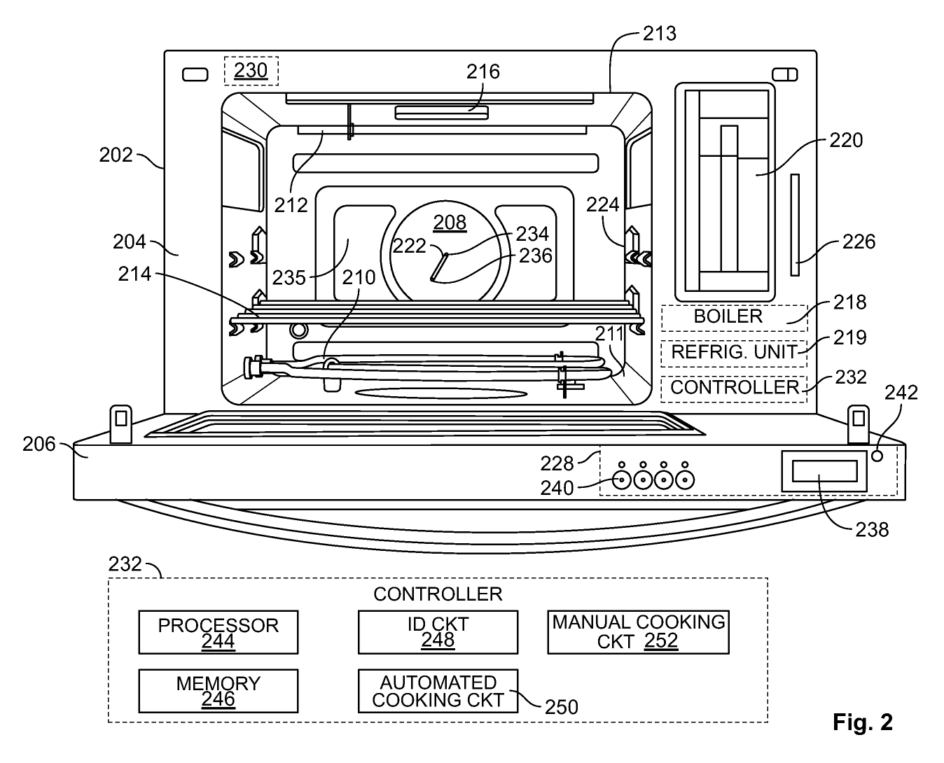

FIG. 2 is a front perspective view of the cooking device 102 of FIG. 1, according to an embodiment. As illustrated in FIG. 2, the cooking device 102 includes an enclosure 202. The enclosure 202 includes a body 204 and a door 206 hingedly coupled to the body 204. The enclosure 202 defines a cooking chamber 208 within the enclosure 202. The cooking chamber 208 defines a volume that may receive the food product 110 (FIG. 1) to controllably apply heat (e.g., dry heat and/or wet heat) to the food product 110 so as to cook the food product 110. Although the embodiment illustrated in FIG. 2 includes one cooking chamber 208, some embodiments include multiple cooking chambers. In the embodiment illustrated in FIG. 2, the door 206 is in an open position in which the door 206 has been rotated away from the body 204 so as to provide access to the cooking chamber 208. The door 206 is rotated to a closed position to cook the food product 110.

The cooking device 102 includes a first heating element 210, a second heating element 212, a rack 214, a fan 216, a boiler 218, a refrigeration unit 219, a water tank 220, a temperature probe 222, a humidity sensor 224, a scanner 226, input/output (“I/O”) devices 228, a network interface 230, and a controller 232.

The first and second heating elements 210, 212 are structured to convert electricity to heat so as to cook the food product 110. The first heating element 210 is positioned proximate a bottom surface 211 of the cooking chamber 208. The second heating element 212 is positioned proximate a top surface 213 of the cooking chamber 208. One or both of the first and second heating elements 210, 212 are utilized, depending on the cooking mode. For example, in some embodiments, only the first heating element 210 is used for baking and only the second heating element 212 is used for broiling. Some embodiments include only one of the first and second heating elements 210, 212.

The rack 214 is structured to support the food product 110 within the cooking chamber 208 to facilitate cooking of the food product 110. According to various embodiments, the rack 214 can be fixed or adjustable in various positions relative to the first and/or second heating elements 210, 212. Some embodiments include multiple racks 214.

The fan 216 is structured to controllably circulate air through the cooking chamber 208. For example, the fan 216 may be controllably operated so as to facilitate convection cooking.

The boiler 218 is structured to boil water stored in the water tank 220 so as to create steam for cooking with “wet heat.” Steam may be utilized in a steaming cooking mode or in combination with other cooking modes. In some embodiments, the cooking device 102 further includes a waste water tank that collects steam that has condensed back into water.

The refrigeration unit 219 is structured to cool the cooking chamber 208 of the cooking device 102. Some embodiments do not include the refrigeration unit 219. The refrigeration unit may be used, for example, to safely store the food product 110 for cooking at a later time. For example, in some embodiments, the user can set a delay on cooking the food product 110. The refrigeration unit 219 will maintain the food product 110 at a safe temperature until the cooking process begins.

The temperature probe 222 is structured to measure one or more temperatures of the cooking device 102. In some embodiments, as illustrated in FIG. 2, the temperature probe 222 includes a first temperature sensor 234 positioned at a first end of the temperature probe 222 proximate or adjacent a back wall 235 of the cooking chamber 208. For example, in one embodiment, the first temperature sensor 234 is embedded in the back wall 235. Accordingly, the first temperature sensor 234 is structured to measure a surface temperature of the back wall 235. The temperature probe 222 also includes a second temperature sensor 236 positioned at a second end of the temperature probe 222 extending from the back wall 235 into the cooking chamber 208. Accordingly, the second temperature sensor 236 is structured to measure a temperature of a particular point within the cooking chamber 208 spaced from the back wall 235. As discussed further in connection with FIG. 6, temperature measurements from the first and second temperature sensors 234, 236 are used to determine a precise spatial temperature map of the cooking chamber 208. The spatial temperature map may be analyzed over time during a cooking process to evaluate various conditions of the food product 110. Although the temperature probe 222 is described herein relative to the back wall 235, it should be understood that the temperature probe 222 may be similarly positioned relative to any wall of the cooking chamber 208. It should be noted that the temperature probe 222 is not structured to be inserted into the food product 110. However, some embodiments may also include a temperature probe that is structured to be inserted into the food product 110.

The scanner 226 is structured to scan the unique identifier 112 on the food product 110. For example, in one embodiment, the unique identifier 112 is a barcode and the scanner 226 is structured to scan the barcode and read the product identifier number from the barcode. The scanner 226 may include any of various types of laser-based or camera-based sensors, or any other type of scanning sensor. In some embodiments, the scanner 226 includes a radio frequency identification (“RFID”) scanner. In some embodiments, the scanner 226 includes a wireless data transmission device, such as a nearfield communication (“NFC”) or Bluetooth transceiver, or any other type of data transmission device. The product identifier is assigned to the food product 110 upon manufacture thereof, and uniquely identifies the food product 110. As will be appreciated, various other details about the food product 110, such as cooking profile, date of manufacture, ingredients, thermal characteristics, etc. may be determined based on the unique identifier.

The I/O devices 228 are structured to receive information from a user and/or to provide information to the user. For example, as illustrated in FIG. 2, the I/O devices 228 include a display 238, buttons 240, and indicator bulbs 242. The display 238 may be utilized, for example, to display a cooking temperature or an amount of time left in a cooking process. The buttons 240 may be utilized to start or stop cooking, to specify a cooking type (e.g., toast, reheat, etc.), to indicate a number of food products 110 being cooked, etc. The indicator bulbs 242 may be illuminated to indicate a status, such as to indicate a connected Wi-Fi signal, to indicate selection of one of the buttons 240, and the like.

The network interface 230 is structured to facilitate operative communication between the cooking device 102, the backend system 104, the user device 106, and other systems and devices, either directly between the systems and devices or via the network 108. In some embodiments, the network interface 230 includes a Wi-Fi 33 enabled network controller. In some embodiments, the network interface 230 includes a cellular or other type of network controller.

The controller 232 is in operative communication with the various components of the cooking device 102, and is structured to controllably operate the various components of the cooking device 102. The controller 232 includes a processor 244, a memory 246, an identification circuit 248, an automated cooking circuit 250, and a manual cooking circuit 252. The memory 246 includes program modules that, when executed by the processor 244, control the operation of the user device 106. The memory 246 may include any combination of RAM, ROM, NVRAM, etc. The memory 246 may also store cooking instructions and other information regarding certain food products 110. For example, the memory 246 may store cooking instructions received from the backend system 104 for use in the event that a network connection is unavailable.

The identification circuit 248, via operative communication with the scanner 226 and the backend system 104, is structured to scan the unique identifier 112 of the food product 110. The identification circuit 248 may retrieve cooking instructions and other characteristics of the food product 110 based on the unique identifier 112 via operative communication with the backend system 104, or by retrieving such information from the memory 246.

The automated cooking circuit 250 is structured to facilitate automated operation of the cooking device 102 for cooking the food product 110 according to the cooking instructions received based on the unique identifier of the food product 110. For example, the automated cooking circuit 250 is structured to controllably operate at least one of the first and second heating elements 210, 212, the fan 216, the boiler 218, and the refrigeration unit 219 according to the received cooking instructions. For example, the automated cooking circuit 250 controls operation al parameters such as voltage and current to operate the components of the cooking device 102. The automated cooking circuit 250 also monitors various conditions such as temperature and humidity values to adjust control of the components.

The manual cooking circuit 252 is structured to facilitate manual operation of the cooking device 102 for cooking the food product 110 according to manually inputted instructions. For example, manual cooking instructions may be defined via user input to the user device 106, the cooking device 102, and/or other systems and devices. The manual cooking circuit 252 also controls operation of the components of the cooking device 102 similar to the automated cooking circuit 250.

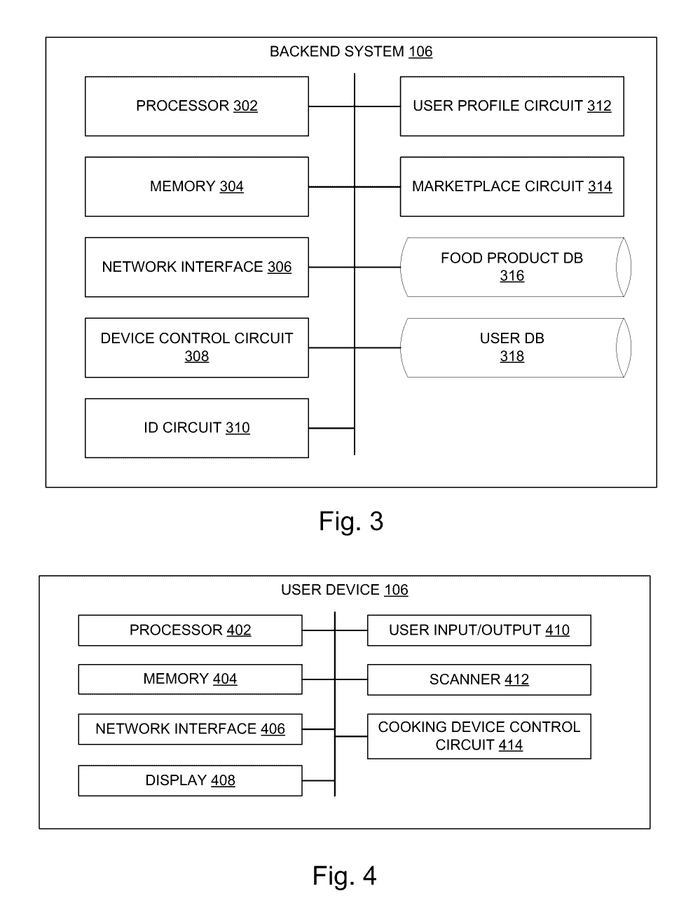

FIG. 3 is a block diagram of the backend system 104 of FIG. 1, according to an example embodiment. The backend system 104 includes a processor 302, a memory 304, a network interface 306, a device control circuit 308, an identifier circuit 310, a user profile circuit 312, a marketplace circuit 314, a food product database 316, and a user database 318. Such circuits and other circuits discussed herein may, in practice, be implemented in a machine (e.g., one or more computers or servers) comprising the processor 302 and memory 304 or machine-readable storage media (e.g., cache, memory, internal or external hard drive or in a cloud computing environment) having instructions stored therein which are executed by the machine to perform the operations described herein. For example, the backend system 104 may include server-based computing systems, for example, comprising one or more networked computer servers that are programmed to perform the operations described herein. In another example, the backend system 104 may be implemented as a distributed computer system where each function is spread over multiple computer systems.

The network interface 306 is structured to facilitate operative communication with the cooking device 102 and the user device 106 via the Internet. In some embodiments, the network interface 306 automatically facilitates authentication of the cooking device 102, for example, by receiving a unique device identifier and verifying that the device identifier corresponds to a valid cooking device 102. In some embodiments, the network interface 306 also facilitates authentication of the user of the cooking device 102. For example, the network interface may also receive a user identifier of the user operating the cooking device 102 and may authenticate that the user has a valid account with the backend system 104.

The device control circuit 308 is structured to facilitate use of the system 100, including control of the cooking device 102, by a user. For example, the network interface 306 may include one or more computers or web servers that provide a graphical user interface (e.g., a series of dynamically-generated web pages) for users that access the backend system 104 using a user device 106 or through the web (e.g., via the user device 106). In other implementations, a user can use a mobile device interface to access the backend system 104. The graphical user interface may be used to prompt the user to provide login information, passwords, or other authentication information (e.g., voice commands, gestures, biometrics, etc.) or other stored tokens. Upon successfully authenticating the user, the graphical user interface may be used to provide the user with an interface to control operation of the cooking device 102 via the user device 106 or via other devices.

The device control circuit 308 may facilitate control of the cooking device 102 by users via both automatic and manual cooking modes of the cooking device 102. For example, in an automated mode, the device control circuit 308 enables a user to initiate a cooking process via the cooking device 102 or via the user device 106. In a manual mode, the device control circuit 308 enables users to select cooking methods, temperatures, and time durations. For example, the device control circuit 308 enables users to programmatically define custom cooking profiles and/or recipes for cooking existing food product types or food products corresponding to particular recipes. In some embodiments, cooking instructions include a cooking profile and a recipe for the particular food product. Users may define the custom cooking profiles using one or more of the input/output device 132 of the cooking device 102, an online interface managed by the backend system 104 or other system, and/or via an app on the user device 106. In some embodiments, cooking instructions include a series of operational conditions specified for certain time periods. For example, one cooking instruction may include heat to 350 deg. F. at 100% humidity from 0-20 minutes, and heat to 500 deg. F. without humidity control from 20-25 minutes. It should be understood that cooking instructions may include any number of steps, each of which may include controlling any number of components of the cooking device 102. Additionally, the cooking instructions may be defined in terms of various parameters, such as cooking chamber temperature, food product temperature or a spatial temperature map (as explained in further detail below), component power, etc.

In some embodiments, a user can utilize any oven-safe container in which to cook food products in manual mode. In such situations, it is not required to scan the food product 110 before cooking it. Instead, the user can select (e.g., via the cooking device 102, the user device 106, etc.) a particular set of cooking instructions and a recipe for cooking the food product 110.

The identifier circuit 310 is structured to create and issue unique identifiers (e.g., alphanumeric strings or other types of unique identification parameters) for the food products 110 as the food products are manufactured. The unique identifiers are provisioned to each food product 110 as each food product 110 is manufactured. The identifier circuit 310 associates various attributes with each unique identifier 112 and stores the unique identifiers and attributes in the food product database 316. According to various embodiments, food product attributes include, for example, one or more of a food product type, manufacturer, critical dates (e.g., production date, expiration date, etc.), nominal cooking instructions, ingredients, thermal profile, storage conditions, blacklist notifications, etc.

The identifier circuit 310 is also structured to receive unique identifiers scanned by the cooking device 102 and/or the user device 106, retrieve the food product attributes from the food product database 316, and transmit the food product attributes to the cooking device 102 and/or the user device 106. In some embodiments, the identifier circuit 310 is also structured to authenticate each food product identifier received from the cooking device 102 or the user device 106. Authentication includes verifying that the unique identifier is included in the food product database 316 to ensure that the food product 110 associated with the unique identifier is a valid and authentic food product that is recognized by the system 100. Authentication may also include determining that the food product 110 associated with the unique identifier 112 has not already been cooked so as to prevent unique identifiers 112 from being reused in an unpermitted manner.

The user profile circuit 312 is structured to generate and maintain profiles for each user of the system 100, which are stored in the user database 318. According to various embodiments, a “user” can be an individual who has set up an account with the system 100, or can be a particular cooking device 102. For example, certain information (e.g., preferences, ratings, etc.) are stored with respect to particular cooking devices 102. In some embodiments, user profile information is stored with respect to particular users. For example, multiple different users may use a single cooking device 102 or a single user may use multiple cooking devices 102. In such situations, cooking parameters may be customized based on the user profile of the user using the cooking device 102. For example, in some embodiments, the user is identified based on operative communication between the cooking device 102 and the user device 106.

In some embodiments, user profiles include cooking preferences. Cooking preferences may be determined in various ways. For example, in some embodiments, users can provide feedback for each meal that they cook. Feedback may include a user's opinion on taste, doneness, portion size, visual appeal, etc. In some embodiments, cooking preferences are determined based on user interaction with the cooking device 102. For example, if a user puts a food product 110 back in the cooking device 102 for a period of time after the standard cooking profile has completed, it may be determined that the user prefers that food product to be cooked further (“more done”). Similarly, if the user removes the food product 110 from the cooking device 102 before its standard cooking profile has completed, and does not later reinsert the food product into the cooking device 102 for further cooking, it may be determined that the user prefers that food product to be cooked less (“less done”). The user profiles continually adapt to the user's usage and feedback so as to learn users' preferences and provide optimal operation tailored for each individual user's preferences.

The marketplace circuit 314 is structured to provide a marketplace for users to purchase, trade, and/or share cooking instructions and/or recipes for cooking food products. For example, in come embodiments, users may post cooking profiles and/or recipes that they have personally developed to the marketplace. Other users may purchase or otherwise retrieve the cooking profiles and/or recipes for their personal use. In some embodiments, the marketplace circuit 314 manages user-generated ratings for each of the cooking profiles and/or recipes. The marketplace provides a social and entrepreneurial aspect to using the cooking device 102 by enabling users to share discuss, review, and sell cooking profiles and/or recipes. Some embodiments include a revenue sharing model in which users keep a percentage of sales for all of the cooking profiles and/or recipes that they have posted. In one implementation, a user can find a recipe in the marketplace and press start to have the cooking instructions sent to the user's cooking device 102.

The marketplace circuit 314 is also structured to provide a marketplace for selling food products 110 to users. The cooking instructions and recipes for cooking the particular food products 110 may be developed by a manufacturer or by a user of the marketplace. For example, in some embodiments, an operating company may offer the submitting users of the highest-rated cooking instructions and recipes to license their cooking instructions and/or recipes to the operating company. The operating company may in turn, pay royalties to the developing user to create and sell food products 110 that utilize particular cooking instructions and recipes.

The food product database 316 includes records of each of the food products 110 produced, which may be indexed by the unique identifier associated with each of the food products 110. The food product database 316 also includes various types of information regarding the food products 110, such as a food product type (e.g., a certain dish), ingredients, recipe, nutritional information, manufacturer, critical dates (e.g., production date, expiration date, etc.), and other types of information. The food product database 316 also includes instructions for cooking the food products 110 based on the unique identifier 112 of the food product 110 and/or based on the food product type or recipe of the food product 110.

The user database 318 includes profiles for each of the users who have registered with the automated cooking system 100. The user profiles may include preferences, operational history, associated cooking devices 102 and user devices 106, etc.

FIG. 4 is a block diagram of the user device 106 of FIG. 1, according to an example embodiment. The user device 106 is structured to receive user input from a user and to provide information to the user to facilitate control of the cooking device 102, management of the user's profile, etc. According to various embodiments, the user device 106 is any of smartphone, a laptop computer, tablet computer, wearable device, internet-of-things (“IoT”) device, augmented reality device, etc.

The user device 106 includes a processor 402 and memory 404. The memory 404 includes program modules that, when executed by the processor 402, control the operation of the user device 106. The memory 404 may also store various applications, such as an application that facilitates communication between the user device 106 and the backend system 104. The memory 404 may include any combination of RAM, ROM, NVRAM, etc.

The user device 106 also includes at least one network interface 406 structured to facilitate operative communication between the user device 106 and the cooking device 102 and/or the backend system 104. In one example, the network interface 406 is a wireless network interface. The network interface 406 includes any of a cellular transceiver (e.g., CDMA, GSM, LTE, etc.), a wireless network transceiver (e.g., 802.11X, Bluetooth, NFC, Bluetooth Low Energy (BLE), RFID, ZigBee, etc.), or a combination thereof (e.g., both a cellular transceiver and a Bluetooth transceiver).

The user device 106 also includes a display 408 and a user input/output 410. The display 408 is structured to present information to a user. The user input/output 410 is structured to present information to and to receive information from the user. In some examples, the display 408 and the user input/output 410 are combined (e.g., as a touchscreen display device). In other examples, the display 408 and the user input/output 410 are discrete devices. The user input/output 410 includes any of touchscreen displays, buttons, speakers, keyboards, notification LEDs, microphones, biometric sensors (e.g., fingerprint scanners), switches, cameras, or a combination thereof.

The user device 106 also includes a scanner 412. The scanner 412 is structured to scan the unique identifier 112 on the food product 110. According to various embodiments, the scanner 412 may include a laser-based or camera-based sensor, or any other type of scanning sensor.

The user device 106 also includes a cooking device control circuit 414. The cooking device control circuit 414 facilitates control of the cooking device 102 by a user in conjunction with the device control circuit 308 of the backend system 104. In one embodiment, the cooking device control circuit 414 includes an application or web interface through which a user may control automatic and manual cooking operations, receive notifications, program custom cooking profiles, etc.

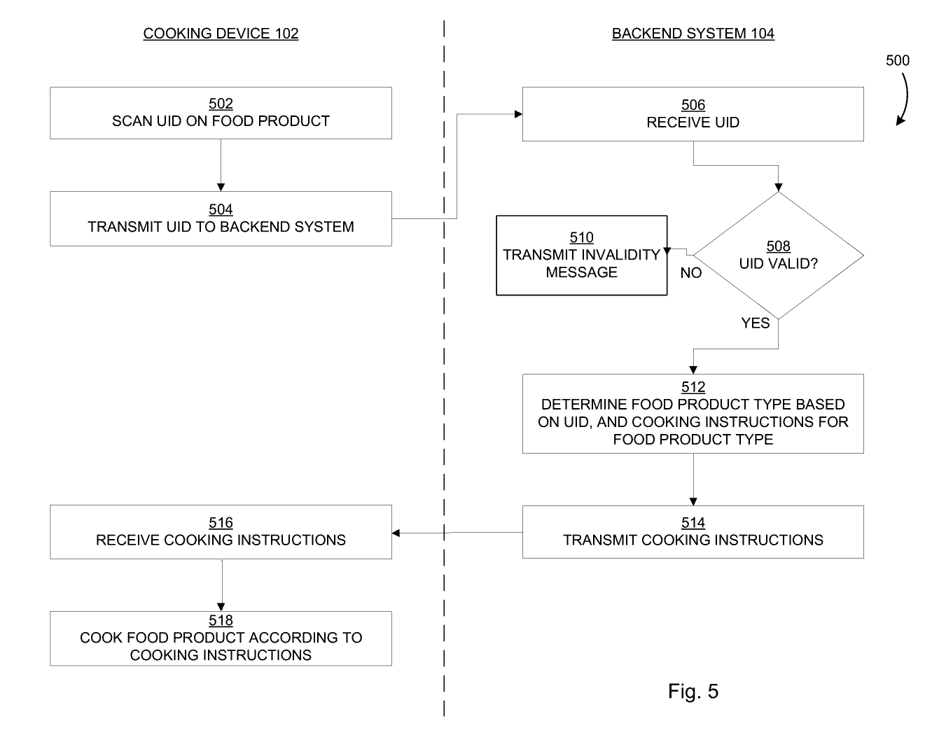

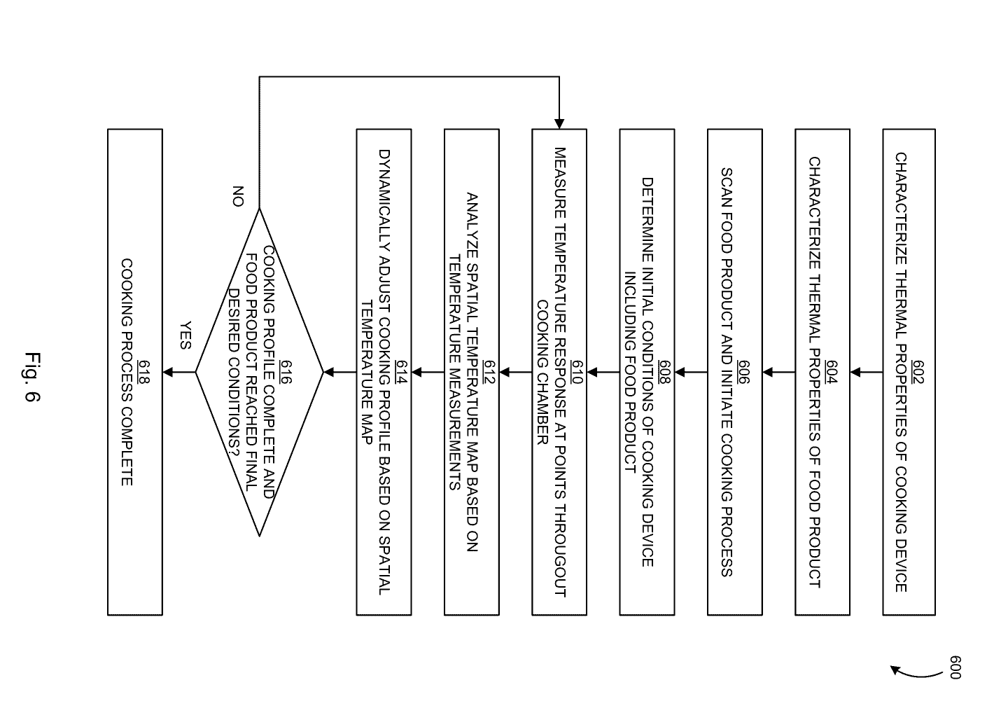

FIG. 5 is a flowchart illustrating a method 500 of initiating a cooking process using the cooking device 102 of FIG. 1, according to an example embodiment. The method 500 is described with respect to the cooking device 102 and the backend system 104 of FIG. 1. However, it should be understood that the method 500 may be similarly performed by other systems and devices. For example, in some embodiments, one or more of the steps performed by the cooking device (e.g., scanning and transmitting the unique identifier 112 of the food product 110) may be similarly performed by the user device 106 of FIG. 1.

At 502, the unique identifier 112 of the food product 110 is scanned. For example, as described, in some embodiments, this involves scanning a barcode on the food product 110 using the scanner 226 of the cooking device 102. In other embodiments, a barcode is similarly scanned using the scanner 412 on the user device 106.

At 504, the unique identifier 112 is transmitted by the cooking device 102 to the backend system 104. The unique identifier 112 may be transmitted with other accompanying data. For example, the unique identifier 112 of the food product 110 may be transmitted with a device identifier of the cooking device 102. The unique identifier 112 may also be transmitted with a user identifier of the particular user using the cooking device 102. The unique identifier 112 may also be transmitted with a time stamp indicating the time that the unique identifier 112 was scanned. In some embodiments, some or all of the information is encrypted prior to being transmitted.

At 506, the backend system 104 receives the unique identifier 112 from the cooking device 102. At 508, the backend system 104 determines whether the received unique identifier 112 is valid. This may include, for example, determining whether the unique identifier 112 matches a food product 110 in the food product database. This may also include determining whether that particular food product 110 has already been cooked, whether it has expired, etc. If the answer to 508 is “NO,” at 510, an invalidity message is transmitted to the cooking device 102. If the answer to 508 is “YES,” the method 500 continues to 512.

At 512, the food product type and the cooking instructions for cooking the particular food product type are determined based on the unique identifier 112. For example, the food product type may be determined by cross-referencing the unique identifier in the food product database. The food product type may indicate, for example, the particular dish or recipe embodied by the food product 110. The food product type may also include an associated serving size of the food product 110. The cooking instructions for cooking the particular food product type may be similarly determined by cross-referencing the unique identifier in the food product database. Other information can also be related to the unique identifier 112. For example, when the food was produced, where (e.g. which facility) the food was produced, sources of the ingredients, the person who assembled the meal, who shipped the meal, when the meal expires, where the user lives because altitude affects cook time, etc. Further, the barcode will be tied to that specific user, who can then rate that specific meal, and we'll be able to evaluate and adjust accordingly. This information can be used to change the cooking instructions. For example, the altitude of where the user lives or is currently located can be used to change the cooking instructions to take into account the altitude. In addition, if a meal has expired the user can be warned before continuing to cook the meal. In other implementations, the oven cannot allow the user to continue to cook an expired meal. Other features are also possible, such as supporting recalls based upon sources of ingredients, where the food was produced, who shipped the meal, etc.

At 514, the cooking instructions are transmitted by the backend system 104 to the cooking device 102. At 516, the cooking instructions are received by the cooking device 102. At 518, the cooking device 102 cooks the food product 110 according to the cooking instructions.

FIG. 6 is a flowchart illustrating a method 600 of dynamically adjusting a cooking profile of a food product 110, according to an example embodiment. The method 600 utilizes advanced dynamic temperature analyses that monitor the thermal response of the food product 110 based on the heating inputs specified by the cooking profile to fine-tailor the cooking profile to the particular food product 110. This enables perfect cooking of the food product 110 regardless of the initial conditions of the food product. For example, whether the food product 110 is completely frozen, partially defrosted, or refrigerated, the method 600 automatically and dynamically adjusts the cooking profile to ensure that the food product 110 is perfectly cooked.

Some conventional cooking devices include a temperature probe that is inserted into the food product to measure its temperature response over time. However, users do not always place the temperature probe in the same part of the food product, so the temperature probe may provide inaccurate and inconsistent readings. For example, instead of placing the temperature probe in the thickest part of a piece of meat, a user may push the temperature probe through the meat so that it contacts the container of the food product. Therefore, the conventional cooking device may think that the temperature of the food product is higher than it actually is. This can result in undercooking the food product, which is undesirable and potentially dangerous. Temperature probes are also undesirable because they may be dangerous to handle when they are hot, and they also provide another part to wash between uses.

The method 600, according to various embodiments, provides a precise understanding of the temperature of the food product 110 without actually having to directly measure the temperature of the food product (e.g., via a temperature probe). Instead, as will be appreciated, the method 600 involves analyzing a dynamic spatial temperature map of the cooking chamber 208 and of the food product 110 as an integrated system based on as few as two temperature measurements, using an advanced parametric model.

At 602, the thermal properties of the cooking device 102 are characterized, without the food product in the cooking device 102. In general, this includes providing a heat input and measuring the resulting temperature response over time relative to the heat input. The temperature response may be measured at various points throughout the cooking device 102, such as on the surfaces of the cooking chamber 208 and at various points throughout the volume of the cooking chamber 208. The thermal properties are generally equivalent from device-to-device, for each particular model of the cooking device 102.

At 604, the thermal properties of the food product 110 are characterized. Similar to characterizing the thermal properties of the cooking device 102, this involves providing a heat input to the food product 110 and measuring the resulting temperature response over time relative to the heat input. The thermal properties of each of the different food products 110 are different. For example, a dense meat-based food product 110 will have different heat capacity than a rice-based food product 110. Accordingly, the thermal properties for each individual food product type are individually determined.

At 604, the food product 110 is scanned and the cooking process is initiated. As described above, upon scanning the food product 110, the unique identifier of the food product 110 is transmitted to the backend system 104 and the backend system 104 returns the cooking instructions for cooking the particular food product 110. The cooking instructions include a nominal cooking profile.

At 606, the initial conditions of the cooking device 102 including the food product 110 are determined. In some embodiments, the initial conditions are determined based on one or more temperature measurements. For example, as discussed above in connection with FIG. 2, in one embodiment, a first temperature on a wall of the cooking chamber 208 is measured by the first temperature sensor 234 and a second temperature within the cooking chamber 208 spaced from the wall is measured by the second temperature sensor 236. It should be understood that other embodiments include other numbers of sensors positioned in any arrangement within the cooking chamber 208 or otherwise within the cooking device 102. The initial conditions may depend on any of various factors, such as the ambient temperature of the room in which the cooking device 102 is situated, the temperature of the food product 110 (e.g., frozen, refrigerated, etc.), the temperature of the cooking chamber 208 (e.g., whether the cooking chamber 208 is still warm or hot by a previous cooking process, cold from a refrigeration process, etc.), and other factors. According to various embodiments, the initial conditions may be determined over different lengths of time. For example, in one embodiment, only single temperature measurements or temperature measurements over a short time period (e.g., 0.5 seconds) are measured to determine the initial conditions. In other embodiments, temperature measurements over a longer period of time (e.g., one minute) are measured to determine the initial conditions.

At 608, the cooking process is begun based on the initial conditions applied to the nominal cooking profile for the food product 110. For example, in some embodiments, the nominal cooking profile includes parameters defined by the initial conditions. The initial conditions are applied to the nominal cooking profile to generate an initial cooking profile. The cooking process is typically begun by heating one or both of the first and second heating elements 210, 212 according to the initial cooking profile.

At 610, the temperature response at various points in the cooking chamber 208 is measured. For example, as discussed above in connection with FIG. 2, in one embodiment, a first temperature on a wall of the cooking chamber 208 is measured by a first temperature sensor 234 and a second temperature within the cooking chamber 208 spaced from the wall is measured by a second temperature sensor 236. It should be understood that other embodiments include other numbers of sensors positioned in any arrangement within the cooking chamber 208 or otherwise within the cooking device 102.

At 612, a spatial temperature map is determined based on the temperature measurements made at 610. The spatial temperature map is determined based on a parametric analysis performed with an array of sensors placed throughout the cooking chamber 208. A parametric model was developed that is structured to determine the special temperature map, including temperatures at multiple (e.g., 16 or more) points throughout the cooking chamber 208, based on two or more temperature measurements. For example, based on the first temperature measurement on the wall of the cooking chamber 208 and the second temperature measurement in the volume of the cooking chamber 208 spaced from the wall, the parametric temperature map model may be used to determine the temperatures at any other point throughout the cooking chamber 208 to a high degree of accuracy.

At 614, the nominal cooking profile for the food product 110 is dynamically adjusted based on the temperature response throughout the cooking chamber 208 and throughout the food product 110 based on the spatial temperature map, relative to the heat inputs. For example, the first and/or second heating elements may be controlled to generate more or less heat depending on whether the temperature response is faster or slower than a nominal temperature response. The dynamic adjustment is performed throughout each step of the cooking profile.

At 616, it is determined whether cooking profile is complete and whether the food product 110 has reached its final desired conditions (e.g., temperatures). If the answer to 616 is “YES,” the cooking process is completed at 618 and the cooking device 102 is powered off. If the answer to 616 is “NO,” the method 600 returns to continue the cooking process.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. §112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. An automated cooking device, comprising:
an enclosure defining a cooking chamber;
a heating element positioned in the cooking chamber, the heating element structured to controllably heat the cooking chamber;
a boiler operatively coupled to the cooking chamber, the boiler structured to controllably inject steam into the cooking chamber;
a fan operatively coupled to the cooking chamber, the fan structured to circulate air within the cooking chamber;
a scanner structured to read a unique identifier on a food product; and
a controller operatively coupled to each of the heating element, the boiler, the fan, and the scanner, the controller structured to:
in response to the scanner reading the unique identifier on the food product, transmit the unique identifier to a backend system,
receive, from the backend system, cooking instructions for controllably operating at least one of the heating element, the boiler, and the fan so as to cook the food product, and
controllably operate the at least one of the heating element, the boiler, and the fan based on the cooking instructions so as to cook the food product.

2. The automated cooking device of claim 1, further comprising a refrigeration unit operatively coupled to the controller, the refrigeration unit structured to cool the cooking chamber.

3. The method of claim 2, wherein the controller is further structured to:
receive a cooking delay parameter, and
prior to controllably operating the at least one of the heating element, the boiler, and the fan based on the cooking instructions so as to cook the food product, controllably operating the refrigeration unit so as to maintain the cooking chamber below a predetermined temperature for based on the cooking delay parameter.

4. The automated cooking device of claim 1, wherein the cooking instructions include custom cooking instructions, the custom cooking instructions determined by modifying nominal cooking instructions for cooking the food product using user preferences associated with the automated cooking device.

5. The automated cooking device of claim 1, wherein the cooking instructions include a plurality of steps, each of the plurality of steps including a cooking process, a temperature, and a duration.

6. The automated cooking device of claim 1, wherein a first cooking process defines operation of the heating element and wherein a second cooking process defines operation of the boiler.

7. The automated cooking device of claim 1, further comprising:
a first temperature sensor operatively coupled to the controller, the first temperature sensor positioned proximate a wall of the cooking chamber; and
a second temperature sensor operatively coupled to the controller, the second temperature sensor positioned within the cooking chamber and spaced from the wall, and
wherein the controller is further structured to:
determine initial temperature conditions based on first temperature measurements from each of the first and second temperature sensors,
upon operating the heating element so as to cook the food product, monitoring second temperature measurements from each of the first and second temperature sensors over time throughout operation of the heating element,
analyzing a spatial temperature map of temperatures throughout the cooking chamber based on the second temperature measurements applied to a parametric temperature map model, and
dynamically adjusting the controllable operation of the at least one of the heating element, the boiler, and the fan relative to the cooking instructions based on the analysis of the spatial temperature map.

8. The automated cooking device of claim 7, wherein none of the first and second temperature sensors are in physical contact with the food product.

9. A method, comprising:
assigning unique identifiers to each of a plurality of food products, the plurality of food products including a plurality of food product types;
defining cooking instructions for cooking each of the food product types;
receiving, from a first automated cooking device, a first unique identifier, the first unique identifier corresponding to a first one of the plurality of food products, the first unique identifier having been scanned by the first automated cooking device from the first food product;
determining the food product type corresponding to the first food product;
determining the cooking instructions corresponding to the first food product type; and
transmitting the determined cooking instructions to the first automated cooking device, the first automated cooking device being structured to cook the first food product according to the determined cooking instructions.

10. The method of claim 9, further comprising:
authenticating the first food product by determining, based on the first unique identifier, that the first unique identifier of the first food product was registered with a registration system, and that the first food product was not previously cooked.

11. The method of claim 10, further comprising disabling cooking of the first food product by the first automated cooking device if the first food product is not authenticated.

12. The method of claim 9, wherein each of the cooking instructions are nominal cooking instructions, and further comprising:
associating the first automated cooking device with a first user;
defining a first cooking preferences profile for the first user, the first cooking preferences profile including a cooking instruction modifier for modifying one of the plurality of nominal cooking instructions.

13. The method of claim 12,
wherein the cooking instruction modifier is associated with the first food product type, and
wherein the cooking instruction modifier is determined based on the first user's interactions with the automated cooking device monitored in connection with cooking at least one other food product of the first food product type.

14. The method of claim 11, further comprising:
determining an expiration date of the first food product; and
disabling cooking of the first food product by the first automated cooking device if the first food product is expired.

15. A method, comprising:
characterizing thermal properties of a cooking device, the cooking device defining a cooking chamber;
characterizing thermal properties of a food product;
defining a parametric temperature map model based on the thermal properties of each of the cooking device and the food product;
receiving nominal cooking instructions for cooking the food product;
determining, upon the food product being placed in the cooking chamber, initial conditions of the cooking device and the food product based on first temperature measurements from each of a first temperature sensor positioned proximate a wall of the cooking chamber and a second temperature sensor positioned within the cooking chamber and spaced from the wall;
determining initial cooking instructions by modifying the nominal cooking instructions based on the initial conditions;
operating the heating element so as to cook the food product according to the initial cooking instructions;
monitoring second temperature measurements from each of the first and second temperature sensors over time throughout operation of the heating element;
analyzing a spatial temperature map of temperatures throughout the cooking chamber based on the second temperature measurements applied to the parametric temperature map model; and
dynamically adjusting the controllable operation of the heating element based on the analysis of the spatial temperature map.

16. The method of claim 15, wherein none of the first and second temperature sensors are in physical contact with the food product.
